(19) United States
(12) Patent Application Publication
(10) Pub. No.: US 2007/0075683 A1
(43) Pub. Date: Apr. 5, 2007

(54) CHARGING MODE CONTROL CIRCUIT AND METHOD

(75) Inventors: Shin-Hong Chung, Shenzhen (CN); Han-Che Wang, Shenzhen (CN); Chun-Wei Pan, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,374

(22) Filed: Aug. 2, 2006

(30) Foreign Application Priority Data
Sep. 16, 2005 (CN) 200510037351.0

(51) Int. Cl. H02J 7/00

(52) U.S. Cl. 320/128

(57) ABSTRACT

The present invention provides a charging mode control circuit and method. By utilizing such charging mode control circuit and method, a secondary battery fixed in a portable device can be quickly charged when the portable device communicate with an external computer. The method includes the steps of: a) providing a commutator, the commutator comprising an adaptor, a first interface, and a second interface, wherein the first interface is connected to the external computer and the second interface is connected to the portable device; b) filtering a charging voltage from the adaptor and obtaining a ripple voltage from the charging power supply; c) rectifying the ripple voltage; d) comparing the rectified ripple voltage with a reference voltage, thereby producing a voltage waveform signal according to a comparison result; and e) selecting a fast charging mode for the secondary battery according to the voltage waveform signal.

### TECHNICAL FIELD

The present invention relates to a charging mode control circuit and method, particularly to a charging mode control circuit and method used in a portable device.

### RELATED ART

Portable devices with Universal Serial Bus (USB) interfaces such as portable computers are welcomed by users for their small size and convenient usage. At present there are generally two solutions for charging a secondary battery equipped in a portable device.

One of the solution is shown in FIG. 1 where a portable device 11 is connected with a computer 12 via their USB interfaces (i.e., USB interface 113 and USB interface 121). According to the protocol standards of USB 1.1 and USB 2.0, the maximum power transmitted by USB interfaces is 2.5 watt (0.5 A @ 5V), in other words, the computer supplies no more than 500 mA charging current under the charging voltage of +5V. Given these circumstances, a secondary battery 111 fixed within the portable device 11 can obtain a charging current from the computer 12 while in-link with the computer, however this charging current is rather small and the charging speed is rather slow.

Another solution is shown in FIG. 2, a portable device 21 is connected to a mains supply 24 via an alternating current to direct current converter (AC/DC) adapter 22. The portable device 21 and the AC/DC adapter 22 both have a USB interface (i.e., USB interface 213 and USB interface 221) for inter-connecting to each other. A secondary battery 211 fixed within the portable device 21 obtains a charging current from a mains supply 24 after the AC/DC adapter 22 performs the voltage transformation. By using such a charging means, a secondary battery 211 fixed within the portable device 21 can obtain a fairly bigger current resulting in a quicker charging speed, however, the portable device will not be able to communicate with an external computer when the battery 211 is charging.

Accordingly, it would be advantageous if the secondary battery fixed in the portable device can obtain a charging current with a fairly faster speed without terminating the data transmission between the computer and the portable device.

### SUMMARY

A charging mode control method is provided. The method is for charging a secondary battery fixed in a portable device during same time period of data communication with an external computer. The method includes the steps of: a) providing a commutator, the commutator comprising an adaptor, a first interface, and a second interface, wherein the first interface is connected to the external computer and the second interface is connected to the portable device; b) filtering a charging voltage from the adaptor and obtaining a ripple voltage from the charging power supply; d) comparing the rectified ripple voltage with a reference voltage, thereby producing a voltage waveform signal according to a comparison result; and e) selecting a fast charging mode for the secondary battery according to the voltage waveform signal.

A charging mode control circuit is further provided. The charging mode control circuit is for selecting an appropriate charging mode for a secondary battery according to a voltage waveform signal. The charging mode control circuit includes: a filtering circuit for filtering a charging voltage and obtaining ripple voltages from the charging voltage; a rectification circuit for rectifying the ripple voltages from the filtering circuit; a comparing circuit having two inputs that receive the rectified ripple voltage and a reference voltage respectively, and an output which outputs a voltage waveform signal according to a comparison result of the rectified ripple voltage and the reference voltage; and a charging control circuit for selecting a corresponding charging mode for the secondary battery according to the voltage waveform signal from the comparing circuit.

A commutator for connecting a portable device and an external communication device is provided. The commutator includes an adapter for obtaining a charging voltage from a mains supply, the AC/DC adapter having a VCC (power) line and a GND (Ground) line; a first interface for connecting an external communication device and transmitting data from the external communication device, the first interface having a VCC pin, a GND pin, and a plurality of data pins; and a second interface for connecting the adapter and the portable device, the second interface having a VCC pin, a GND pin, and a plurality of data pins; wherein the GND pin and the data pins of the second interface respectively connect to the GND pin and the data pins of the first interface, and the GND pin and the VCC pin of the second interface further connect to the GND line and the VCC line of the adapter respectively.

Based on the present invention, the secondary battery can be charged in a fast-charging mode by inserting the commutator which include the AC/DC adaptor therein between the communication device and the portable device. The AC/DC adaptor provides a relative large current for the charging mode control circuit, which make it feasible to charge the secondary battery fixed within the portable device quickly during data transmission with an external communication device.

### BRIEF DESCRIPTION OF THE DRAWINGS

FIG. 1 is a block diagram of an exemplary application of prior charging means;

FIG. 2 is a block diagram of another exemplary application of prior charging means;

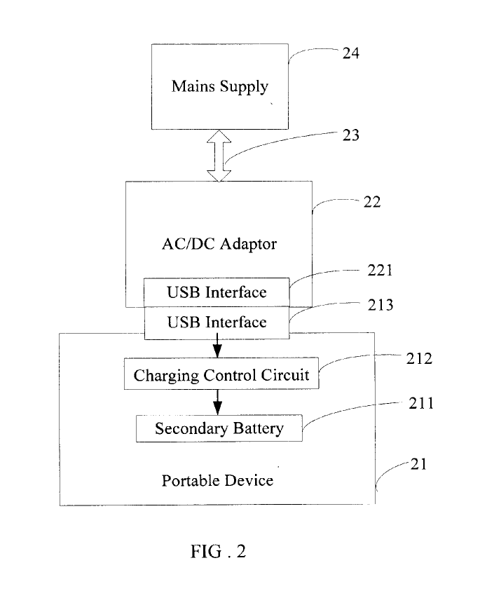

FIG. 3 is a block diagram of an exemplary application of a charging mode control circuit and method in accordance with a preferred embodiment of the present invention; and

FIG. 4 depicts details of an exemplary charging mode control circuit of FIG. 3.

### DETAILED DESCRIPTION OF THE EMBODIMENTS

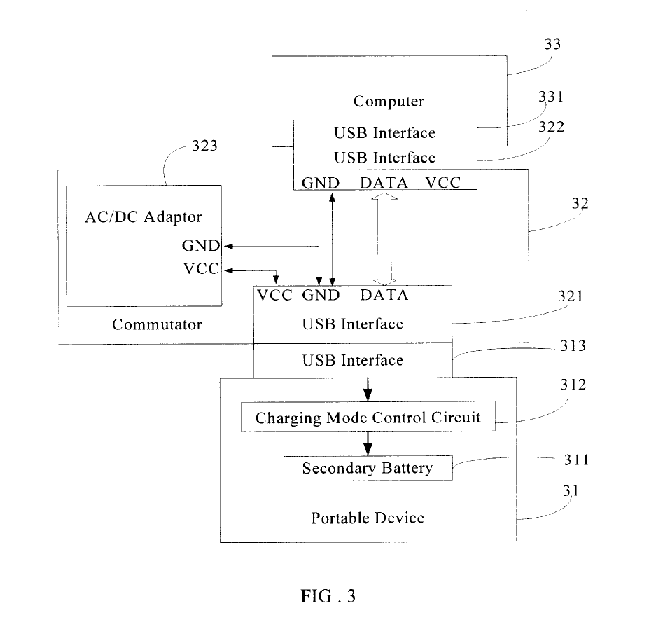

FIG. 3 is a block diagram of an exemplary application of a charging mode control circuit and method in accordance with a preferred embodiment of the present invention. Shown here are a portable device 31, a commutator 32, and a computer 33. The portable device 31 has a charging mode control circuit 312 incorporated therein and a secondary battery 311 fixed therein. The charging mode control circuit 312 is used to select a selective charging mode on the secondary battery 311 according to a peculiar charging power supply available.

The commutator 32 includes an adapter 323 and two USB interfaces 321 and 322. The USB interface 321 is connected directly to the USB interface 313 of the portable device 31 and the USB interface 322 is connected directly to the USB interface 322 of the computer 33. Each of the USB interfaces 321 and 322 has a VCC (power) pin, a GND (ground) pin, and a plurality of DATA pins. The AC/DC adapter 323 has a VCC line and a GND line. The VCC pin and the GND pin of the USB interface 321 are respectively connected to the VCC line and the GND line of the AC/DC adapter 323, thereby obtaining a charging power supply from an external power supply (not shown) via the AC/DC adapter 323. Furthermore, the GND pin and DATA pins of the USB interface 321 are respectively connected to the GND pin and DATA pins of the USB interface 322, thereby communicating with the computer 33 when the USB interface 322 is connected to a USB interface 331 of the computer 33. The VCC pin of the USB interface 322 is kept idle.

Thus, by utilizing such connections, the portable device 30 not only can quickly obtain the charging power supply with a fairly great current (larger than 500 mA) from the external mains supply, but can also perform data communications with the computer 33. During this charging process, the charging mode control circuit 312 chooses a rapid charging mode on the secondary battery 311.

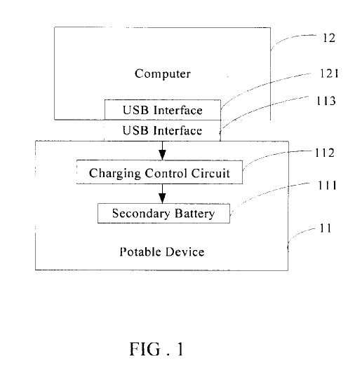

FIG. 3 shows the charging mode of the secondary battery 311 obtaining a large charging current (referred to as “a fast-charging mode”). If the portable device 11 is associated with the computer 12 via their own USB interfaces (i.e., USB interface 313 and USB interface 331) similar to FIG. 1, the secondary battery 311 obtains a small charging current (referred to as “a slow-charging mode”). The two charging modes both support data communication between the portable device 31 and the computer 33 while the secondary battery 311 is charging.

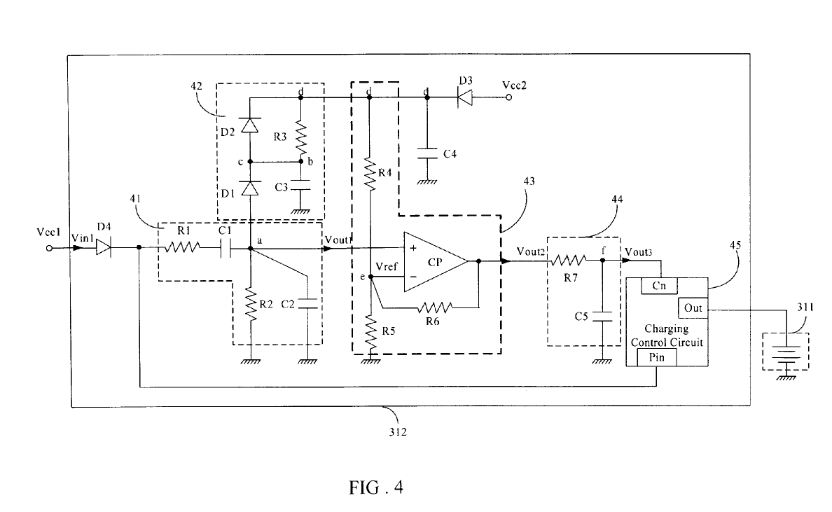

FIG. 4 depicts details of an exemplary charging mode control circuit. Shown here are a charging mode control circuit 312 and a secondary battery 311. The charging mode control circuit 312 mainly includes a filtering circuit 41, a protecting circuit 42, a comparing circuit 43, an integral circuit 44, and a charging control circuit 45.

The filtering circuit 41 includes two resistances R1 and R2, and two capacitors C1 and C2. The resistance R1 and the capacitor C1 have a serialized combination therebetween (referred to as a “serial R1C1”), and the resistance R2 and the capacitor C2 have a parallelized combination therebetween (referred to as a “parallel R2C2”). A resistance end of the serial R1C1 is connected to a cathode of a diode D4, and a capacitance end of the serial R1C1 is connected to an end of the parallel R2C2 (namely, node “a”). The node “a” further connects to an anode of a diode D1 of the protecting circuit 42 and a positive input of the comparing circuit 43. In addition, the other end of the parallel R2C2 is connected to an analog ground (GND).

The protecting circuit 42 includes two diodes D1 and D2, a resistance R3, and a capacitor C3. The diodes D1 and D2 have a serialized combination therebetween (referred to as a “serial D1D2”). The resistance R3 and the capacitor C3 have a serialized combination therebetween (referred to as a “serial R3C3”). A cathode of diode D2 is connected to a resistance end of the serial R3C3 (namely, node “d”). The node “d” further connects to a cathode of a diode D3, an end of a capacitor C4, and a resistance R4 of the comparing circuit 43. In addition, the other end of the serial R3C3 is connected to the analog ground (GND). The diode D1 and diode D2 have a node “c” therebetween, as well as the resistance R3 and capacitance C3 have a node “b” therebetween. The node “b” is further directly connected to the node “c”.

The comparing circuit 43 includes a comparator CP, a reference voltage generating circuit, and a feedback circuit. The comparator CP has a positive input and an inverse input. The reference voltage generating circuit has two serialized resistances R4 and R5 (referred to as a “serial R4R5”). The feedback circuit has a resistance R6. The comparing circuit 43 associates with the filtering circuit 41 by a resistance R4 connecting to the node “d” and associates with the protecting circuit 42 by the positive input of the comparator CP. The serial R4R5 has a node “e” therebetween. The node “e” is connected to the inverse input of the comparator CP and the resistance R6. One end of the serial R4R5 is connected to the cathode of the diode D3 for receiving a reference voltage Vcc2 that is filtered by a filtering circuit component of the diode D3 and the capacitance C4. The other end of the serial R4R5 is connected to the analog ground (GND). As to the feedback circuit, two end of the resistance R6 are respectively connected to the output of the comparator CP and the inverse input of the comparator CP.

The integral circuit 44 includes a resistance R7 and a capacitance C5. One end of the resistance R7 is connected to the output of the comparator CP, and the other end of the resistance R7 is serially connected to one end of the capacitance C5 by a node “f”. The other end of the capacitance C5 is connected to the analog ground (GND). The node “f” is also connected to the charging control circuit 45.

The charging control circuit 45 includes two input ports “Cn” and “Pin”, and an output port “Out”. The input port “Cn” is connected to the node “f”, and the input port “Pin” is connected to the charging voltage Vin1 (Vcc1). The output port “Out” is connected to the secondary battery 311.

The filtering circuit 41 receives a charging voltage Vin1 (VCC1), (including direct voltage and alternating voltages with various amplitudes) from an external power supply (e.g., a computer or a mains supply), and filters out the direct voltage therein, thereby obtaining the alternating voltages (referred to as “ripple voltage Vout1”). Further, the ripple voltage Vout1 is a resultant voltage from a plural of voltages with various amplitudes. The amplitudes of the plural of voltages are different due to different external power supplies. Therefore, the ripple voltage Vout1 has different amplitudes in regards to the different external power supplies. For example, if the external power supply is the mains supply, the amplitude of the maximum voltage Vm1 of the ripple voltage Vout1 is equal to or more than 100 mV; alternatively, if the external power supply is the computer 33, the amplitude of the maximum voltage Vm2 of the ripple voltage Vout1 is less than 100 mV.

The voltage comparing circuit 43 receives the ripple voltage Vout1 via the positive input of the comparator CP and the reference voltage Vref via the inverse input of the comparator CP. The comparator CP produces a selective voltage waveform Vout2 after comparing the ripple voltage Vout1 with the reference voltage Vref. The reference voltage Vref can be set according to the ripple voltage Vout1, that is, the reference voltage Vref is in a range from Vm1 to Vm2. For example, supposing Vm1 is 500 mV and Vm2 is 100 mV, for simplicity, the reference voltage Vref is set to 300 mV. Given these circumstances, if the ripple voltage Vout1 is filtered from the mains supply, the voltage waveform Vout2 is a rectangular-wave; if the Vout1 is filtered from the computer, the voltage waveform Vout2 is a continuous low voltage level waveform.

The integral circuit 44 integrates the selective voltage waveform Vout2 and produces a corresponding control waveform single Vout3. If the voltage waveform Vout2 is a rectangular-wave, the waveform of the control waveform single Vout3 is a saw-tooth waveform or a triangle waveform; if the voltage waveform Vout2 is a continuous low voltage level waveform, the waveform of the control waveform single Vout3 is also a continuous low voltage level waveform.

The charging control circuit 45 identifies the charging power supply according to the control waveform single Vout3 from the integral circuit 44, and selects a selective charging mode on charging the secondary battery 311. The input port “Pin” receives the voltage Vin1 (Vcc1) from the VCC pin of the USB interface 313, and the input port “Cn” receives the charging control waveform Vout3 from the output of the integral circuit 44. The output port “Out” outputs a selective charging current for the secondary battery 311.

For example, if the voltage waveform signal Vout3 is a triangle wave, the charging control circuit 45 selects the fast-charging mode on the secondary battery 311 with a relative large charging current between 0 mA and 1000 mA; if the voltage waveform Vout3 is the continuous low voltage level waveform, the charging control circuit 45 selects the slow-charging mode on the secondary battery 311 with a relative small charging current between 0 mA and 500 mA.

The protecting circuit 42 here is used to prohibit an impairment caused by a large instantaneous charging current Vin1. As described, a voltage of the node “a” is equal to the ripple voltage Vout1, and a voltage of the node “d” is supplied from the reference voltage supply Vcc2. Therefore, under normal conditions, the diode D1 maintains a cut-off state because the amplitude of the ripple voltage Vout1 held on the node “a” is far less than the amplitude of the voltage held on the node “d” supplied from the reference voltage supply Vcc2. When a very large instantaneous voltage surges in the charging voltage Vcc1, the amplitude of the ripple voltage Vout1 held on the node “a” is larger than the amplitude of the voltage held on the node “d” that is supplied by the reference voltage supply Vcc2, thereupon the protecting circuit 42 initiates to work and the capacitance C3 eliminates the very large instantaneous charging voltage for prohibiting the impairment to the charging mode control circuit 312.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A charging mode control method for charging a secondary battery fixed in a portable device at the same time of data communication with an external communication device, the method comprising the steps of:
filtering a charging voltage and obtaining a ripple voltage from the charging voltage;
comparing the ripple voltage with a reference voltage, thereby producing a voltage waveform signal according to a comparison result;
integrating the voltage waveform signal and thereby producing a charging control signal; and
selecting a charging mode for the secondary battery according to the charging control signal.

2. The charging mode control method according to claim 1, wherein the charging voltage is selected from the group consisting of a voltage from an adaptor and a voltage from an external communication device.

3. The charging mode control method according to claim 2, wherein the charging mode is selected from the group consisting of a fast-charging mode and a slow-charging mode.

4. The charging mode control method according to claim 3, wherein the selecting step further comprises the steps of:
selecting the slow-charging mode for the secondary battery if an amplitude of the ripple voltage filtered from the external communication device is less than an amplitude of the reference voltage; and
selecting the fast-charging mode for the secondary battery if the amplitude of the ripple voltage filtered from the adaptor is greater than the amplitude of the reference voltage.

5. A charging mode control circuit for selecting a charging mode for a secondary battery, the charging mode control circuit comprising:
a filtering circuit for filtering a charging voltage and obtaining a ripple voltage from the charging voltage;
a comparing circuit for comparing an amplitude of the ripple voltage with an amplitude of a reference voltage generated from a reference voltage generator, and outputting a voltage waveform signal according to a comparison result;
an integral circuit for integrating the voltage waveform signal and outputting a voltage control signal; and
a charging control circuit for selecting a corresponding charging mode for the secondary battery according to the voltage control signal from the integral circuit.

6. The charging mode control circuit according to claim 5, wherein the charging voltage is selected from the group consisting of a voltage from an adaptor and a voltage from an external communication device.

7. The charging mode control circuit according to claim 5, wherein the comparing circuit comprises a reference voltage generating circuit and a comparator, the comparator including at least two inputs and an output.

8. The charging mode control circuit according to claim 7, wherein the reference voltage generating circuit comprises at least two resistances, and the resistances are connected in series with at least a node, and one end of the connected resistances is connected to a reference supply and the other end of the connected resistances is connected to an analog ground.

9. The charging mode control circuit according to claim 8, wherein the inputs of the comparator are respectively connected to the node of the series connected resistances for receiving the reference voltage and the filtering circuit for receiving the ripple voltage, and the output of the comparator is connected to the integral circuit.

10. The charging mode control circuit according to claim 9, wherein the comparator outputs the comparison result to the integral circuit after comparing the reference voltage with the ripple voltage.

11. The charging mode control circuit according to claim 10, wherein the comparing circuit further comprises a feedback circuit consisted by a resistance whose two ends connect to one input of the comparator and the output of the comparator.

12. The charging mode control circuit according to claim 11, wherein the input of comparator the feedback circuit connected to further connected to the reference voltage.

13. The charging mode control circuit according to claim 5, wherein the charging mode control circuit further comprises a protecting circuit for prohibiting an impairment caused by a large instantaneous charging current, the protecting circuit being connected between the filtering circuit and the reference circuit.

14. The charging mode control circuit according to claim 5, wherein the charging mode control circuit further comprises a power input port connected to a charging power supply, a charging control input port connected to the integrating circuit, and an output port connected with the secondary battery.

15. A commutator for connecting a portable device and an external communication device, by which a secondary battery fixed in the portable device is charged at the same time of communicating with the computer, the commutator comprising:
an adapter for obtaining a charging voltage from a mains supply, the adapter having a VCC line and a GND line;
a first interface for connecting an external computer and obtaining data from the external computer, the first interface having a VCC pin, a GND pin, and a plurality of DATA pins; and
a second interface for connecting the adapter and the portable device, the second interface having a VCC pin, a GND pin, and a plurality of DATA pins; wherein:
the GND pin and the DATA pins of the second interface are respectively connected to the GND pin and the DATA pins of the first interface, and the GND pin and the VCC pin of the second interface further are respectively connected to the GND line and the VCC line of the adapter.

16. The commutator according to claim 15, wherein the VCC pin of the first interface is kept idle.

17. The commutator according to claim 15, wherein the first interface and the second interface are USB interfaces.
